(19) United States
(12) Patent Application Publication
(10) Pub. No.: US 2008/0155980 A1
(43) Pub. Date: Jul. 3, 2008

(54) Hydrostatic Stepless Transmission

(76) Inventors: Koji Sakata, Amagasaki-shi (JP); Yasuhisa Mochizuki, Amagasaki-shi (JP)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/617,182

(22) Filed: Dec. 28, 2006

(51) Int. Cl. F16D 31/02

(52) U.S. Cl. 60/433

(57) ABSTRACT

A hydrostatic stepless transmission comprises a variable displacement hydraulic pump and a hydraulic servomechanism. The hydraulic servomechanism includes a cylinder chamber, a piston, a slidable member, a pair of pressure reception chambers, and positioning means. The piston is slidably fitted in the cylinder chamber. The slidable member is disposed in the piston so as to constitute a swash plate angle control valve for the hydraulic pump. The pair of pressure reception chambers are formed in the cylinder chamber on the opposite sides of the piston in the slide direction of the piston. By changing a position of the slidable member relative to the piston, one of the opposite pressure reception chambers is supplied with pressure fluid so as to slide the piston and to tilt a movable swash plate of the hydraulic pump connected to the piston, thereby changing a displacement of the hydraulic pump. The positioning means is disposed in at least one of the pressure reception chambers. The positioning means locates the piston at a neutral position for stopping pressure fluid supply to the pressure reception chamber hydraulic servomechanism, in correspondence to the slidable member located at a position corresponding to a neutral position of a movable swash plate of the hydraulic pump when an engine for driving another hydraulic pump for supplying pressure fluid into the pressure reception chambers is stationary.

### BACKGROUND OF THE INVENTION

1. Field of the Invention

The present invention relates to a hydrostatic stepless transmission including a hydraulic pump and a hydraulic motor, in which an angle/angles of a movable swash plate/plates of the hydraulic pump or/and motor is/are controlled.

2. Related Art

Conventionally, there is a well-known hydrostatic stepless transmission (hereinafter referred to as “HST”) including a hydraulic pump and a hydraulic motor, with a hydraulic servomechanism for controlling a tilt angle/angles of a movable swash plate/plates of the variable displacement hydraulic pump or/and motor, as disclosed in JP 2004-11769 A. One conventional hydraulic servomechanism is an automotive type having an electromagnetic valve/valves connected to the hydraulic pump or the HST so as to automatically tilt the movable swash plate/plates in proportion to increase of the rotary speed of the hydraulic pump. Another conventional hydraulic servomechanism is a manual servomechanism for controlling the movable swash plate of the hydraulic pump by operating a speed control operation lever provided outside the HSTs.

The HST disclosed in the reference is provided with a hydraulic servomechanism for the hydraulic pump, in which a speed control cylinder is connected to the movable swash plate of the hydraulic pump and is controlled by a speed control valve so as to control the tilt of the movable swash plate. The HST is also provided with a servomechanism for the hydraulic motor, in which a switching cylinder for moving the movable swash plate of the hydraulic motor is shifted by an electromagnetic changeover valve so as to select one of tilt states of the movable swash plate.

An example of concrete structure of the hydraulic servomechanism is as follows. A slidable member (spool) is fitted in a piston slidably disposed in a cylinder chamber so as to constitute a swash plate angle control valve. The relative position between the spool and the piston is changed so as to supply pressure fluid into one of pressure reception chambers on opposite sides of the piston in the slide direction of the piston, thereby tilting the movable swash plate connected to the piston.

In this structure, the spool is operatively connected to a speed controlling operation device, such as a speed control pedal, disposed in a driver's section of a vehicle equipped with the HST, so as to be moved by operating the speed controlling operation device. An additional hydraulic pump (charge pump) is driven by an engine so as to charge pressure fluid to the HST, and this charged pressure fluid is used as the pressure fluid supplied to the pressure reception chambers.

### SUMMARY OF THE INVENTION

Description will now be given of the problems, objects of the invention for solving the problems, and aspects of the invention for achieving the objects.

The hydraulic servomechanism having the swash plate angle control valve, which is configured in the piston so as to be actuated by charged pressure fluid, has a first problem as follows: Charged pressure fluid is introduced into a pressure reception chamber by moving a spool in the swash plate angle control valve, and the hydraulic pressure of the introduced fluid slides the piston. If the engine is stationary, the swash plate angle control valve is not supplied with the charged pressure fluid. Therefore, when the engine is stationary, the piston is not located correspondingly to the position of the spool even if the spool is located at a position corresponding to the neutral position of the movable swash plate.

Accordingly, when the engine is stationary, the tilt position of the movable swash plate cannot be decided because of the unlocation of the piston. Consequently, for example, when a vehicle having the HST is disposed on a slope and the engine is stopped, the vehicle cannot be surely stopped.

To solve the problem, it is noticed that an elastic member is provided for biasing the piston to the maximum tilt angle (referred to as the maximum swash plate position) for forward traveling during the stationary state of the engine such as to stop the charged pressure fluid supply to the hydraulic servomechanism. Due to the elastic member, while the engine is stationary, the pressure reception chamber is surely fluidly tightened so as to locate the piston for ensuring a braking force.

This arrangement prevents the piston from being wrongly located when the engine is stationary. However, when the engine is restarted while the piston biased by the elastic member is disposed at the maximum swash plate position for forward traveling, the forward traveling drive torque is generated by cranking with a starting motor or the like before the charged pressure is increased to a sufficient level. When the torque exceeds the braking force caused by the correctly located piton, the vehicle may creep. In other words, even when the speed control operation device is disposed at the neutral position (i.e., zero-speed position), the vehicle may unexpectedly creep on starting of the engine. The creep on starting of the engine should be avoided for safety.

Further, when the HST is combined with a planetary gear mechanism so as to constitute an HMT (hydro-mechanical transmission), the engine power is transmitted to the HST through the planetary gear mechanism. As a result, the tilt angle range of the movable swash plate of the hydraulic pump includes an angle causing the HST to idle when the planetary gear mechanism rotates synchronously to the drive shaft of the hydraulic pump or in another case. The vehicle cannot be surely stopped on a slope if the piston is disposed at the angle causing the HST to idle while the engine is stationary.

A first object of the invention is to provide a hydrostatic stepless transmission provided with a hydraulic servomechanism including a piston, which is slid by hydraulic pressure charged by a swash plate angle control valve so as to control a tilt of a movable swash plate connected to the piston, wherein the hydraulic servomechanism is configured so as to prevent a vehicle from creeping when an engine starts, and which surely keep a stationary vehicle on a slope.

To achieve the first object, a hydrostatic stepless transmission comprises a variable displacement hydraulic pump and a hydraulic servomechanism. The hydraulic servomechanism includes a cylinder chamber, a piston slidably fitted in the cylinder chamber, and a slidable member disposed in the piston so as to constitute a swash plate angle control valve for the hydraulic pump. The hydraulic servomechanism further includes a pair of pressure reception chambers formed in the cylinder chamber on opposite sides of the piston in the slide direction of the piston. In the hydraulic servomechanism, by changing a position of the slidable member relative to the piston, one of the opposite pressure reception chambers is supplied with pressure fluid so as to slide the piston and to tilt a movable swash plate of the hydraulic pump connected to the piston, thereby changing a displacement of the hydraulic pump. The hydraulic servomechanism further includes positioning means provided to at least one of the pressure reception chambers. The positioning means locates the piston at a neutral position for stopping pressure fluid supply to the pressure reception chamber hydraulic servomechanism, in correspondence to the slidable member located at a position corresponding to a neutral position of a movable swash plate of the hydraulic pump when an engine for driving another hydraulic pump for supplying pressure fluid into the pressure reception chambers is stationary.

Therefore, when the engine is stopped and the charged hydraulic pressure in the swash plate angle control valve reaches zero, the piston reaches the vicinity of the neutral position. Consequently, a vehicle is prevented from creeping on restarting of the engine, and the vehicle is surely kept stationary on a slope.

There is a conventional HST including hydraulic pump and motor, both of which have variable displacements. During speed changing (acceleration), a movable swash plate of the hydraulic pump is tilted from a neutral position for stopping suction and delivery of fluid, and after the movable swash plate of the hydraulic pump reaches its maximum tilt angle, i.e., after the displacement of the hydraulic pump reaches the maximum level, a movable swash plate of the hydraulic motor having been disposed at the maximum tilt angle is tilted in the direction for reducing the displacement of the hydraulic motor (toward a neutral position). In this structure, a hydraulic servomechanism for controlling a tilt angle of the movable swash plate of the hydraulic motor has a swash plate angle control valve in a piston as mentioned above, so that the swash plate angle control valve is actuated by charged pressure fluid. This hydraulic servomechanism has a second problem as follows.

Charged pressure fluid is introduced into a pressure reception chamber by moving a spool in the swash plate angle control valve, and the hydraulic pressure of the introduced fluid slides the piston. If the engine is stationary, the swash plate angle control valve is not supplied with the charged pressure fluid. Therefore, when the engine is stationary, the piston is not located correspondingly to the position of the spool even if the spool is located at a position corresponding to the maximum tilt angle of the movable swash plate.

For example, when the piston is disposed at a position corresponding to the vicinity of the neutral position of the movable swash plate and the engine is stopped so as to keep the piston at the position, engine brake action is insufficiently obtained. In this regard, unless the movable swash plate of the hydraulic pump reaches the maximum tilt angle, and unless the acceleration operation is further performed after the movable swash plate of the hydraulic pump reaches the maximum tilt angle, the movable swash plate of the hydraulic motor is held at the maximum tilt angle (for the maximum displacement of the hydraulic motor). However, if the piston is kept at the position corresponding to the vicinity of the neutral position of the movable swash plate, the amount of fluid, which is sucked and delivered to and from the hydraulic motor for driving a drive shaft of the hydraulic motor is small so as to reduce the rotary force applied onto the drive shaft (i.e., an output shaft of the HST), thereby reducing the brake action onto the drive shaft of the hydraulic motor. Consequently, when the vehicle is stopped on a slope, load is transmitted from the axle to the drive shaft of the hydraulic motor, however, the applied engine brake is insufficient for overcoming the load.

A second object of the invention is to provide a hydrostatic stepless transmission provided with a hydraulic servomechanism including a piston, which is slid by hydraulic pressure charged by a swash plate angle control valve so as to control a tilt of a movable swash plate connected to the piston, wherein the hydraulic servomechanism is configured so as to surely apply engine brake for surely keeping a vehicle stopped on a slope.

To achieve the second object, a hydrostatic stepless transmission comprises a variable displacement hydraulic motor and a hydraulic servomechanism. The hydraulic servomechanism includes a cylinder chamber, a piston slidably fitted in the cylinder chamber, and a slidable member disposed in the piston so as to constitute a swash plate angle control valve for the hydraulic motor. The hydraulic servomechanism further includes a pair of pressure reception chambers formed in the cylinder chamber on opposite sides of the piston in the slide direction of the piston. In the hydraulic servomechanism, by changing a position of the slidable member relative to the piston, one of the opposite pressure reception chambers is supplied with pressure fluid so as to slide the piston and to tilt a movable swash plate of the hydraulic motor connected to the piston, thereby changing a displacement of the hydraulic motor. The hydraulic servomechanism further includes biasing means disposed in the pressure reception chamber on the slide side of the piston for moving the movable swash plate toward a neutral position. The biasing means biases the piston so as to locate the piston at a position corresponding to a maximum swash plate angle of the movable swash plate of the hydraulic motor for stopping supply of fluid to the pressure reception chamber, in correspondence to the slidable member located at a position corresponding to the maximum swash plate angle of the movable swash plate when an engine for driving a hydraulic pump for supplying pressure fluid into the pressure reception chambers is stationary.

Therefore, when the engine is stopped and the swash plate angle control valve comes to be supplied with no charged pressure, the piston is located at the maximum swash plate angle position (corresponding to the maximum tilt angle of the movable swash plate of the hydraulic motor) so as to surely apply engine brake, thereby surely parking a vehicle on a slope.

These, further and other objects, features and advantages will appear more fully from the following description with reference to accompanying drawings.

### BRIEF DESCRIPTION OF THE DRAWINGS

FIG. 1 is a front view partly in section of an entire structure of an HST according to the invention.

FIG. 2 is a sectional side view of the HST.

FIG. 3 is a rear view partly in section of the HST.

FIG. 4 is a sectional plan view of the HST.

FIG. 5 is a sectional side view of load controlling systems.

FIG. 6 is a fragmentary expanded view of FIG. 1.

FIG. 7 is a view of speed control levers of the hydraulic servomechanisms.

FIG. 8 is a sectional view of a load controlling system for a hydraulic pump.

FIG. 9 is a sectional view of a load controlling system for a hydraulic motor.

FIG. 10 is a hydraulic circuit diagram of the HST according to the invention.

FIG. 11 is a sectional view of a hydraulic servomechanism for the hydraulic pump.

FIG. 12 is a sectional view of another hydraulic servomechanism for the hydraulic pump.

FIG. 13 is a sectional view of a hydraulic servomechanism for the hydraulic motor.

### DETAILED DESCRIPTION OF THE INVENTION

An embodiment of the invention will be described. A hydrostatic stepless transmission (HST) according to the invention is applicable to working vehicles, such as an agricultural working vehicle, e.g., a tractor, and a working vehicle equipped with a loader. The following description will be given of an HST provided to a working vehicle equipped with a loader.

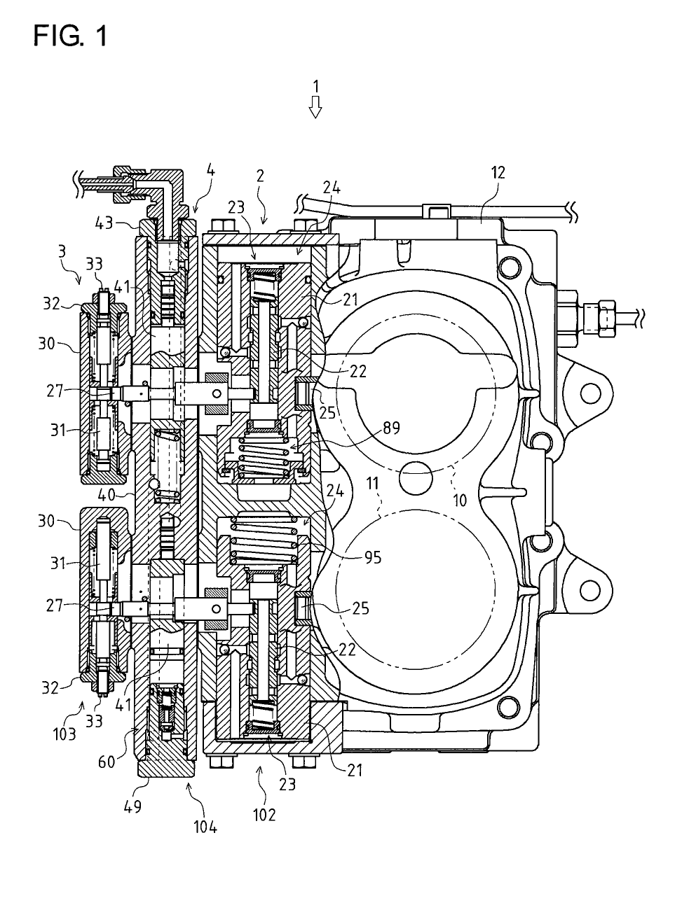

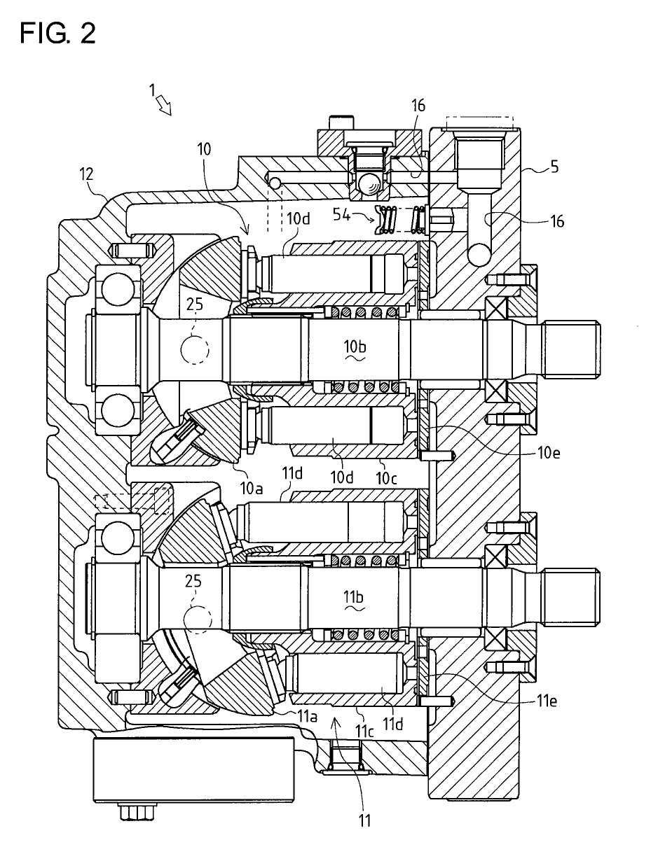

An entire configuration of an HST 1 according to the invention will be described with reference to FIGS. 1 to 4. As shown in FIGS. 1 and 2, in the HST, a housing 12 incorporates a variable displacement hydraulic pump 10 and a variable displacement hydraulic motor 11.

Further, housing 12 incorporates a hydraulic servomechanism 2, which adjusts a tilt angle of a movable swash plate 10a of hydraulic pump 10 so as to control the output rotation of hydraulic pump 10, a hydraulic servomechanism 102, which adjusts a tilt angle of a movable swash plate 11a of hydraulic motor 11 so as to control the output rotation of hydraulic motor 11, a neutral-position holding system 3, a maximum swash plate angle holding system 103, load controlling systems 4 and 104, and others.

Unless a special mention is given, only representative devices for hydraulic pump 10, such as hydraulic servomechanism 2 and neutral-position holding system 3, will be described. In this regard, in the present embodiment, hydraulic motor 11 is provided with devices (hydraulic servomechanism 102 and maximum-swash-plate-angle-position holding system 103), which are substantially equal to the devices (hydraulic servomechanism 2 and neutral-position holding system 3) for hydraulic pump 10.

In this embodiment, hydraulic pump 10 and motor 11 are variable in displacement. Alternatively, one of hydraulic pump 10 and motor 11 may be variable in displacement, and the other may be fixed in displacement.

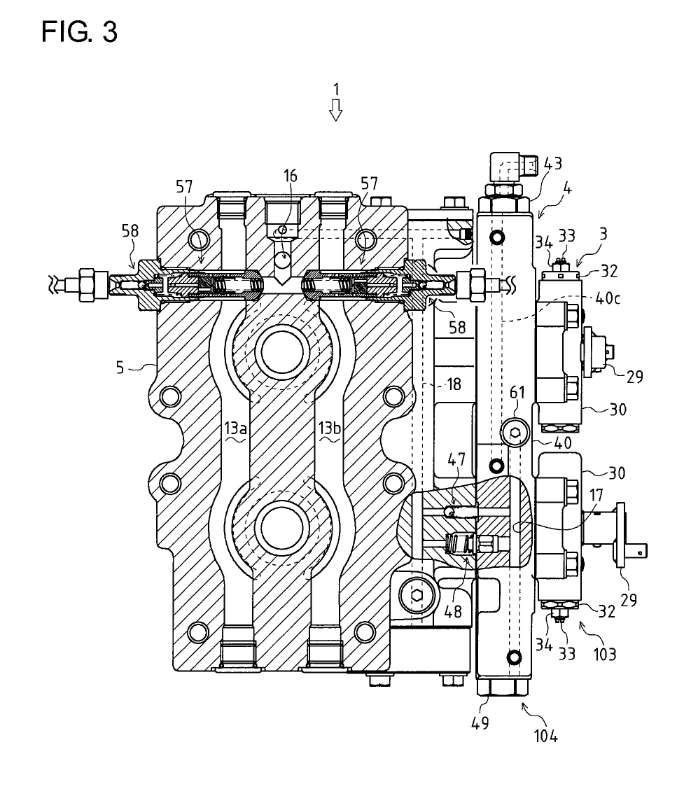

As shown in FIG. 2, hydraulic pump 10 and motor 11 are disposed in housing 12, and are mounted onto a common surface of a duct plate 5 so as to be vertically juxtaposed substantially in parallel. A pair of main fluid passages 13a and 13b (generally or representatively named as “main fluid passage/passages 13”) are formed in duct plate 5 (see FIG. 3) so as to constitute a closed circuit fluidly connecting hydraulic pump 10 and motor 11 to each other.

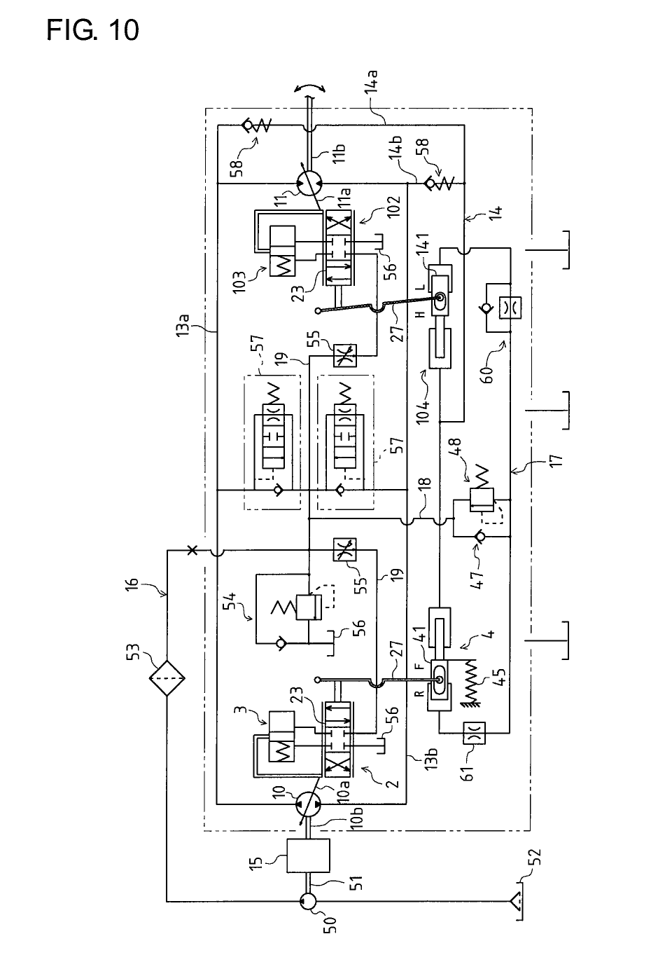

Variable displacement hydraulic pump 10, including a drive shaft 10b, a cylinder block 10c and a plurality of plungers 10d, is provided with a movable swash plate 10a. Drive shaft 10b serves as an input shaft of HST 1. Drive shaft 10b is inserted into duct plate 5, and is supported by housing 12, so as to receive power from an engine 15 (see FIG. 10). Cylinder block 10c is relatively unrotatably fitted on drive shaft 10b so as to be rotatably integral with drive shaft 10b. Plungers 10d are air-tightly and slidably fitted into respective cylinder bores in cylinder block 10c through respective biasing springs. Movable swash plate 10a is rotatably supported by housing 12 so as to serve as a swash plate cam for reciprocally moving plungers 10d, thereby defining slide strokes of plungers 10d. A valve plate 10e is interposed between cylinder block 10c and duct plate 5 and has drive shaft 10b passed therethrough.

In hydraulic pump 10 having the above structure, the plurality of plungers 10d abutting against movable swash plate 10a rotate so as to deliver pressure fluid to hydraulic motor 11 through main fluid passages 13 formed in duct plate 5. Movable swash plate 10a has a surface whose angle relative to the axis of drive shaft 10b is changeable. When the surface of movable swash plate 10a is perpendicular to the axis of drive shaft 10b, hydraulic pump 10 is set in a neutral state for delivering no pressure fluid to hydraulic motor 11 regardless of rotation of drive shaft 10b. By tilting the surface of movable swash plate 10a from the position where the surface is perpendicular to the axis of drive shaft 10b, hydraulic pump 10 delivers pressure fluid to hydraulic motor 11 according to rotation of drive shaft 10b. By adjusting the tilt angle of movable swash plate 10a, the delivery amount of fluid per rotation of drive shaft 10b is adjusted so as to adjust the delivery amount of fluid from hydraulic pump 10, thereby adjusting the rotary speed and direction of a driven shaft 11b of hydraulic motor

Similar to hydraulic pump 10, variable displacement hydraulic motor 11, including driven shaft 11b, a cylinder block 11c and a plurality plungers 11d, is provided with a movable swash plate 11a. Driven shaft 11b serves as an output shaft of HST 1, so as to output the power of engine 15. Description of movable swash plate 11a, cylinder block 11c, plungers 11d and a valve plate 11e is omitted because they are similar to those of hydraulic pump 10.

In hydraulic motor 11, the tilt angle of movable swash plate 11a is adjusted so as to adjust the amount of pressure fluid sucked to hydraulic motor 11. However, the maximum tilt angle of movable swash plate 11a (for establishing the maximum displacement of hydraulic motor 11) is kept unless movable swash plate 10a of hydraulic pump 10 reaches its maximum tilt angle, and unless a speed control operation for accelerating the vehicle is performed with movable swash plate 10a reaching the maximum tilt angle.

Due to this structure, drive shaft 10b of hydraulic pump 10 receives the power of engine 15 so as to drive hydraulic pump 10. Operating fluid delivered by driving hydraulic pump 10 is supplied to hydraulic motor 11 through main fluid passage 13 in duct plate 5, thereby driving hydraulic motor 11, and transmitting the rotary force of hydraulic motor 11 to driven shaft 11b.

With respect to the speed control (acceleration) of HST 1, during the speed control operation after the displacement of hydraulic pump 10 reaches the maximum, i.e., after the tilt angle of movable swash plate 10a reaches the maximum, movable swash plate 11a of hydraulic motor 11 is tilted in a direction for reducing the displacement of hydraulic motor 11 (toward a neutral position thereof).

Hydraulic servomechanism 2 will now be described. As shown in FIGS. 1, 2, 5 and 7, in HST 1, hydraulic pump 10 and hydraulic motor 11 are vertically (maybe laterally) juxtaposed, hydraulic servomechanism 2 for hydraulic pump 10 is disposed on one side of hydraulic pump 10, and hydraulic servomechanism 102 for hydraulic motor 11 is disposed on one side of hydraulic motor 11 and under hydraulic servomechanism 2 for hydraulic pump 10.

Hydraulic servomechanism 2 includes a piston 21 and a swash plate angle control valve 23 having a spool 22 disposed in piston 21. These components are integrally disposed in housing 12 of the HST.

Swash plate angle control valve 23 is configured so that a cylinder chamber 24 is formed in a portion of housing 12 sidewise from movable swash plate 10a of hydraulic pump 10, and piston 21 is slidably fitted in cylinder chamber 24. A pin shaft 25 projects from a side portion of movable swash plate 10a and is fitted to a side surface of piston 21. Piston 21 has an axial penetrating hole in which spool 22 is slidably fitted.

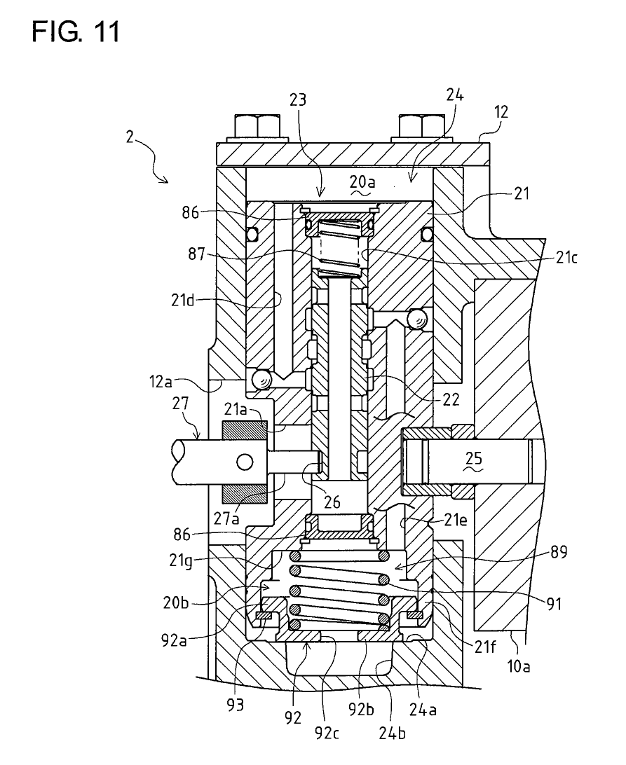

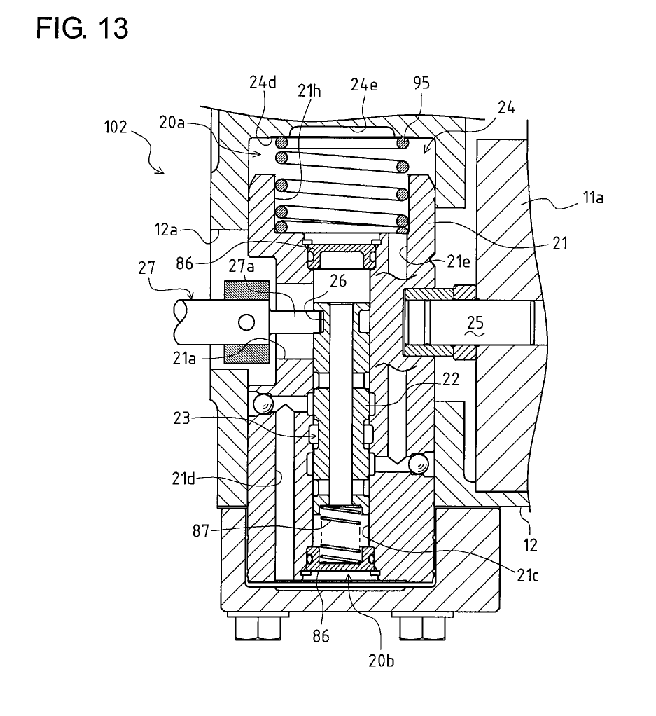

Piston 21 is formed therein with a fluid passage 21d connected to a pressure reception chamber 20a of cylinder chamber 24 above piston 21, and with a fluid passage 21e connected to a pressure reception chamber 20b of cylinder chamber 24 below piston 21 (see FIGS. 11 and 13). Spool 22 slides so as to connect or disconnect the fluid passages formed in piston 21 to and from each other. When the fluid passages are connected to each other, fluid is passed between pressure reception chambers 20a and 20b above and below piston 21 (in cylinder chamber 24) so as to vertically slide piston 21.

Cap members 86 are fitted into respective openings of opposite ends of penetrating hole 21c of piston 21. A spring 87 is interposed between spool 22 and one cap member 86 (in this embodiment, upper cap ember 86), so as to adjust the relative position of spool 22 to piston 21 in cooperation of hydraulic pressures from pressure reception chambers 20a and 20b.

Spool 22 is formed at a lower peripheral surface thereof with an engagement groove 26, into which a first end portion 27a of pin 27, serving as a speed-controlling motive member (of spool 22) of hydraulic servomechanism 2, is engaged. A second end portion 27b of pin 27 is nipped by a twisted spring 28 constituting later-discussed neutral-position holding system 3. Housing 12 is formed at a side surface thereof with an opening 12a, piston 21 is formed at a side surface thereof with an opening 21a, and first end portion 27a of pin 27 is inserted into housing 12 through openings 12a and 21a, and is engaged into engagement groove 26 as mentioned above.

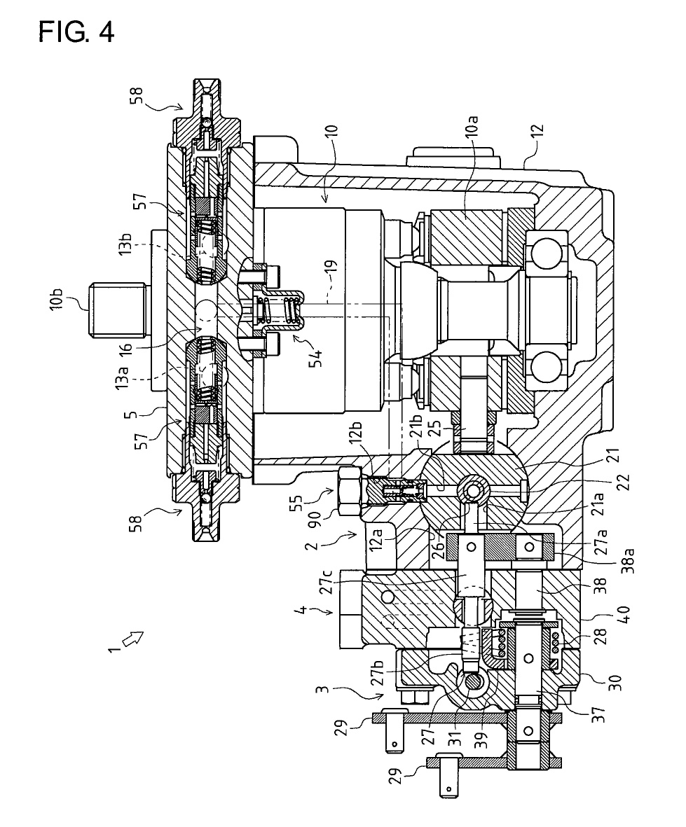

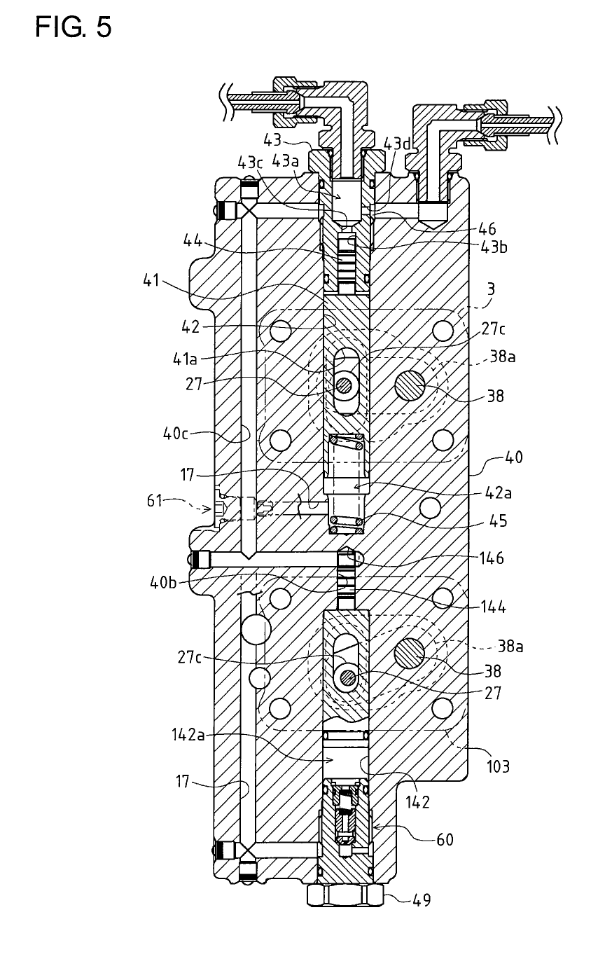

As shown in FIGS. 4 and 5, a cylinder 40 is attached onto a side of housing 12 so as to constitute load controlling systems 4 and 104 (later-discussed), a pivot shaft 38 is supported by cylinder 40, and pin 27 is rotatably supported onto pivot shaft 38 through a support arm 38a. In other words, pivot shaft 38 is supported substantially in parallel to pin 27, and pin 27 is supported at first end portion 27a by support arm 38a fixed on pivot shaft 38 so as to be rotatably centered on pivot shaft 38.

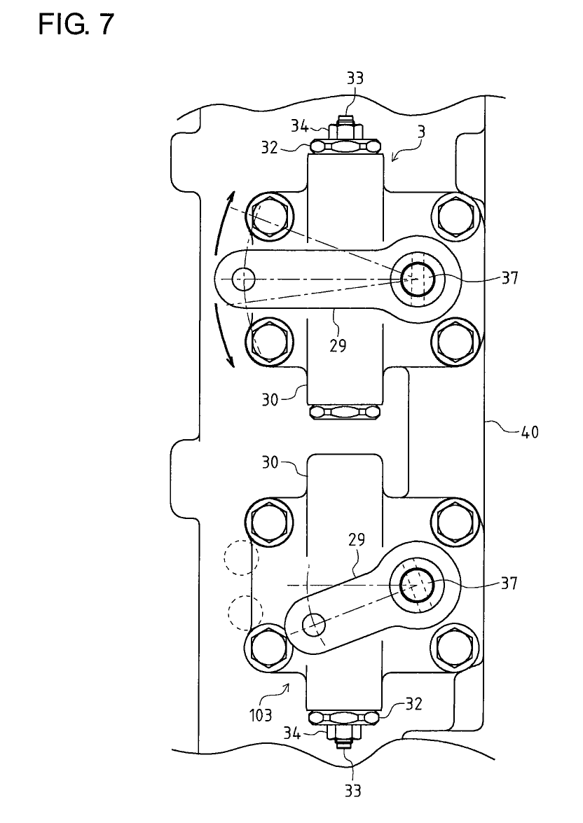

A speed control operation lever 29 of hydraulic servomechanism 2 interlocks with pin 27 so that, by operating speed control operation lever 29, pin 27 is moved vertically (in FIGS. 1 and 7) against the force of twisted spring 28 so as to vertically move spool 22.

In this way, piston 21 is slid by change of fluid passage in swash plate angle control valve 23 by sliding spool 22, thereby tilting movable swash plate 10a of hydraulic pump 10 for speed-controlling HST 1.

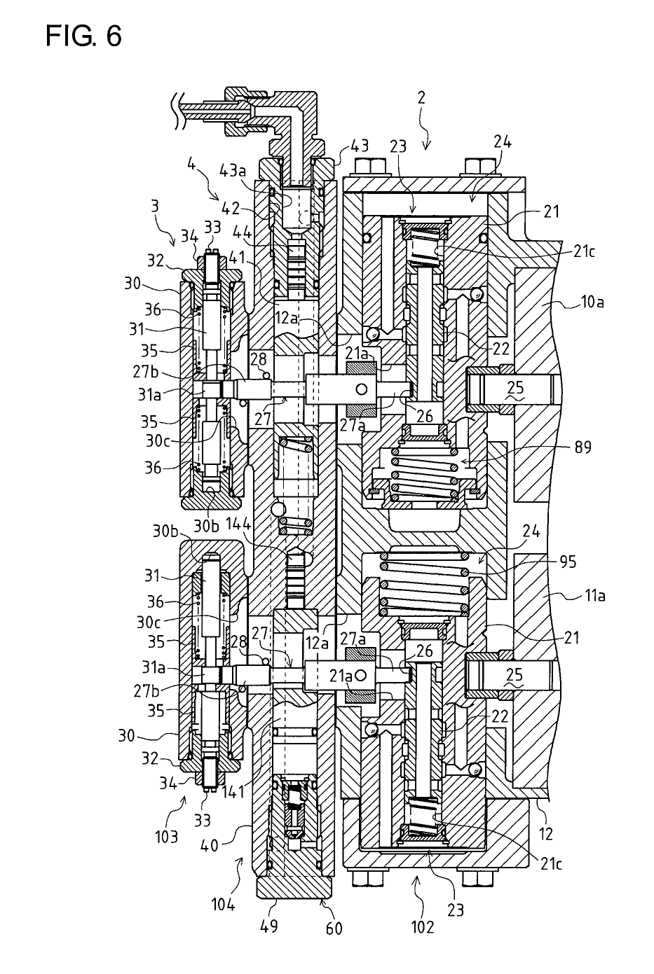

Neutral-position holding system 3 and others will be described. As shown in FIGS. 1, 4, 6 and others, neutral-position holding system 3 is disposed opposite to hydraulic servomechanism 2 with respect to load controlling system 4, so as to hold movable swash plate 10a of hydraulic pump 10 at its neutral position. Neutral-position holding system 3 is disposed in a casing 30. A detent rod 31 is axially (in FIGS. 1 and 6, vertically) slidably disposed in an inner space of casing 30.

Detent rod 31 is supported at a first end thereof in recess 30b, which is formed by casing 30 or is formed in a cap screwed into casing 30. Detent rod 31 is supported at a second end thereof by a cap 32 screwed into casing 30. An adjusting bolt 33 is formed integrally on the second end portion of detent rod 31 so as to be screwed into cap 32. Detent rod 31 is longitudinally (i.e., axially) slidable by rotating adjusting bolt 3, and normally fixed in place by a lock nut 34.

A fixture portion 31a is formed on a substantially middle portion of detent rod 31. Second end portion 27b of pin 27 is pointed to fixture portion 31a and is inserted into the inner space of casing 30. In this regard, second end portion 27b of pin 27 has a diameter, which is substantially as large as the width of fixture portion 31a (i.e., the axial length of detent rod 31 at fixture portion 31a).

In the inner space of casing 30, a pair of spring retainers 35 are axially slidably disposed on opposite sides of fixture portion 31a of detent rod 31. A pair of springs 36 are interposed between casing 30 or the cap and spring retainer 35, and between cap 32 and spring 35. Spring retainers 35 are biased toward fixture portion 31a by respective springs 36. Namely, fixture portion 31a of detent rod 31 and second end portion 27b of pin 27 are pressed in the opposite directions so as to be nipped between spring retainers 35.

As shown in FIG. 4, speed control operation lever 29 is supported by casing 30 so as to be rotatably centered on a pivot shaft 37. Twisted spring 28 is rotatably wound around pivot shaft 37 so as to nip second end portion 27b of pin 27. A connection arm 39 is fixed on pivot shaft 37 so as to be rotatably integral with pivot shaft 37, and is nipped by twisted spring 28.

When speed control operation lever 29 is rotated, connection arm 39 fixed on pivot shaft 37 and twisted spring 28 nipping connection arm 39 are rotated integrally with speed control operation lever 29. In other words, when speed control operation lever 29 is rotated, pin 27 rotates integrally with speed control operation lever 29 through connection arm 39 and twisted spring 28, so as to slide spool 22 of hydraulic servomechanism 2. In this way, speed control operation lever 29, pivot shaft 37, connection arm 39 and twisted spring 28 and others constitute a speed control operation lever unit.

Unless speed control operation lever 29 is rotated, second end portion 27b of pin 27 is nipped together with fixture portion 31a of detent rod 31 between spring retainers 35, thereby holding the rotational position of pin 27 corresponding to fixture portion 31a. In HST 1 according to the present embodiment, movable swash plate 10a of hydraulic pump 10 is disposed at its neutral position when speed control operation lever 29 is free from an operation force and second end portion 27b of pin 27 is held by spring retainers 35.

In this way, neutral-position holding system 3 has detent rod 31, springs 36 and spring retainers 35, so as to hold the neutral position of movable swash plate 10a of hydraulic pump 10 through pin 27 and hydraulic servomechanism 2.

In other words, neutral-position holding system 3 supports pin 27, which interlocks with movable swash plate 10a of hydraulic pump 10 through hydraulic servomechanism 2, by the biasing of twisted spring 28 and the like, so as to hold movable swash plate 10a at the neutral position. Pivot shaft 37 of speed control operation lever 29 is engaged to the intermediate portion of pin 27 for sliding spool 22 through connection arm 39 and twisted spring 28, so as to operatively integrate pin 27 with speed control operation lever 29. First end portion 27a of pin 27 is extended in one direction from the portion of pin 27 engaged to pivot shaft 37 so as to drive spool 22, and second end portion 27b of pin 27 is extended in the other direction from the portion of pin 27 engaged to pivot shaft 37 so as to be engaged to detent rod 31, thereby defining the neutral position.

Neutral-position holding system 3 configured as mentioned above is provided with an adjusting mechanism (a neutral-position adjusting mechanism) for minutely adjusting the neutral position. In this regard, detent rod 31 is axially movable by rotating adjusting bolt 33 screwed into cap 32. If movable swash plate 10a of hydraulic pump 10 deviates from its neutral position while pin 27 is held at the position corresponding to fixture portion 31a, adjusting bolt 33 is rotated so as to adjust the position of fixture portion 31a of detent rod 31, thereby correctly locating movable swash plate 10a at the neutral position while pin 27 is held at the position corresponding to fixture portion 31a.

On the other hand, maximum swash plate angle holding system 103 is provided to hydraulic motor 11. Maximum swash plate angle holding system 103 is configured substantially similar to neutral-position holding system 3, however, maximum swash plate angle holding mechanism 103 is adapted to hold movable swash plate 11a of hydraulic motor 11 at the maximum tilt angle.

Maximum swash plate angle holding system 103 includes a zero-degree angle adjusting mechanism, similar to the neutral-position adjusting mechanism of neutral-position holding system 3. The zero-degree angle adjusting mechanism has adjusting bolt 33 so that, when movable swash plate 11a of hydraulic motor 11 deviates from its zero-degree angle, adjusting bolt 33 is rotated so as to correctly locate movable swash plate 11a at its zero-degree angle.

Due to this configuration, as shown in FIG. 7, speed control operation lever 29 for hydraulic pump 10 is disposed substantially horizontally when movable swash plate 10a of hydraulic pump 10 is disposed at the neutral position. When speed control operation lever 29 is rotated upward or downward centered on pivot shaft 37, movable swash plate 10a of hydraulic pump 10 is tilted through hydraulic servomechanism 2. Another speed control operation lever 29 for hydraulic motor 11 is disposed downwardly slantwise when movable swash plate 11a of hydraulic motor 11 is disposed at the maximum tilt angle. When this speed control operation lever 29 is rotated upward centered on its pivot shaft 37, movable swash plate 11a of hydraulic motor 11 is tilted toward its neutral position. The pair of speed control operation levers 29 are operatively connected to a speed control operation device, such as a pedal or a lever, (which can select whether the traveling direction of the vehicle is forward or backward) in a driver's section of the vehicle. A speed control operation of the speed control operation device from a zero speed position to a certain speed position causes rotation of speed control operation lever 29 of hydraulic pump 10, and a speed control operation of the speed control operation device to increase the speed from that corresponding to the certain speed position causes rotation of speed control operation lever 29 of hydraulic motor 11.

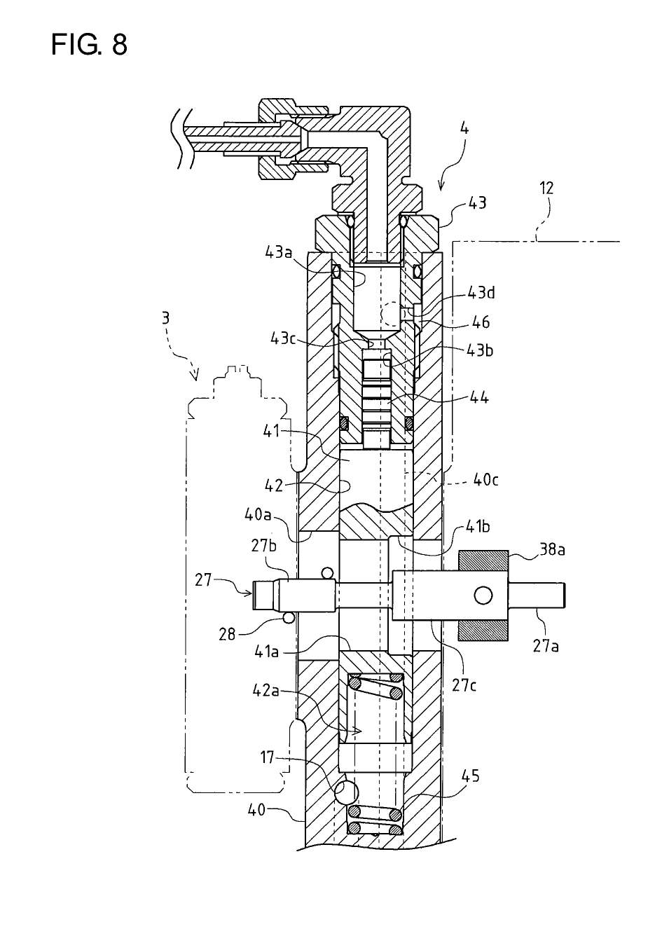

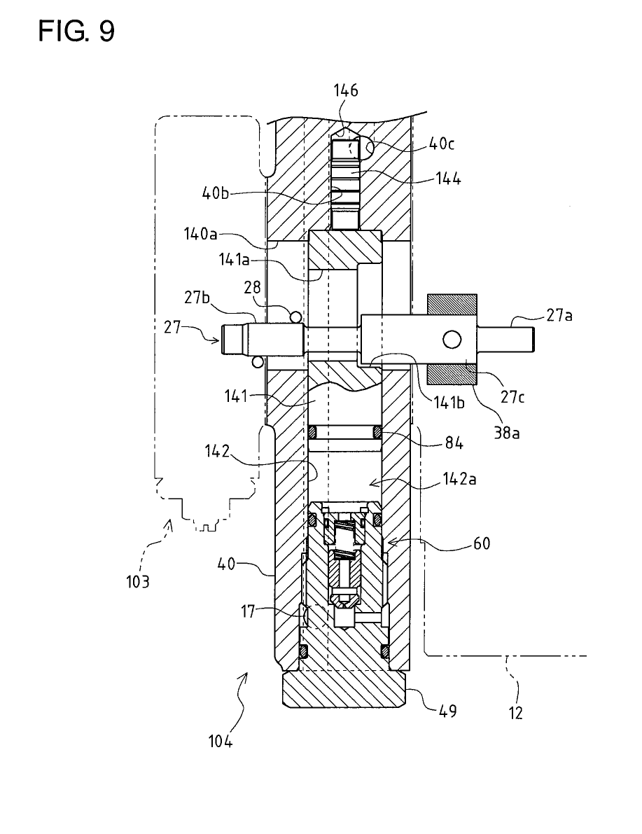

Load controlling systems 4 and 104 will be described with reference to FIGS. 5, 6, 8 and 9. First, description will be given of load controlling system 4 for hydraulic pump 10. Load controlling system 4 includes cylinder 40 and a spool 41. Pressure fluid from main fluid passage 13 is supplied and drained to and from cylinder 40. Spool 41 is slidably fitted in cylinder 40 and is engaged to pin 27 serving as the speed-controlling motive member. In cylinder 40, main fluid passage 13 is connected to a first side of spool 41, so that, when load is controlled, spool 41 is pushed by hydraulic pressure from main fluid passage 13 so as to move pin 27 engaging with spool 41. Therefore, load controlling system 4 controls the tilt angle of movable swash plate 10a of hydraulic pump 10 independently of the tilt operation of movable swash plate 10a by operating speed control operation lever 29 according to the speed control operation device provided in the driver's section of the vehicle (by hydraulic servomechanism 2 or so on).

Cylinder 40 is vertically extended along a substantially flat side wall surface of housing 12, and attached to the side wall surface of housing 12 so as to be interposed between hydraulic servomechanism 2 and neutral-position holding system 3. An upwardly opened vertical cylinder hole 42 is bored in cylinder 40, and substantially columnar spool 41 is slidably fitted in cylinder hole 42.

A pipe joint 43 is screwed into the opened (top) end of cylinder hole 42 so as to be connected to a fluid passage for the pressure fluid supplied from main fluid passage 13, so that the pressure fluid from main fluid passage 13 is supplied into cylinder 40 through pipe joint 43. An opening 40a laterally penetrates a vertical intermediate portion of cylinder 40 so as to have pin 27 passed therethrough.

Pipe joint 43 is screwed into cylinder hole 42 so as to fluidly tightly fit an inner peripheral surface of pipe joint 43. A fluid suction-and-delivery port 43a is provided in joint pipe 43. Pressure fluid is led from main fluid passage 13 into fluid suction-and-delivery port 43a so that its hydraulic pressure is detected. Pipe joint 43 is bored therein with a pin hole 43b opened toward spool 41. A pin 44 is slidably inserted into pin hole 43b and abuts at one end thereof against an upper surface of spool 41.

Pin hole 43b is connected to fluid supply-and-delivery port 43a in pipe joint 43 through an orifice 43c. In this regard, pressure fluid in fluid supply-and-delivery port 43a is supplied into pin hole 43b through orifice 43c so as to slide pin 44 according to hydraulic pressure in main fluid passage 13. For example, when the hydraulic pressure in main fluid passage 13 is increased, pin 44 is pushed outward from pin hole 43b so that spool 41 is pressed and slid downward by pin 44.

Spool 41 is bored at a substantially longitudinally middle portion thereof by a vertical long penetrating hole 41a, through which pin 27 is passed. Penetrating hole 41a is opened to opening 40a of cylinder 40 while spool 41 is fitted in cylinder hole 42. Since cylinder 40 is interposed between housing 12 and casing 30, opening 40a is opened at one side thereof to openings 12a and 21a formed in respective side surfaces of housing 12 and piston 21, and is opened at the other side thereof to an opening 30c formed in a side surface of casing 30. Opening 40a of cylinder 40, penetrating hole 41a of spool 41 and others constitute a free-passage space, in which pin 27 is disposed so as to penetrate load controlling system 4 (including cylinder 40 and spool 41) in the shorter direction of load controlling system 4.

Spool 41 is formed at an edge thereof around the opening of penetrating hole 41a with a notched portion 41b, which is notched so as to expand penetrating hole 41a. Bar-shaped pin 27 is formed thereon with a large diameter portion 27c corresponding to notched portion 41b. Accordingly, due to the slide of spool 41 in the longitudinal direction of cylinder 40 (vertically), notched portion 41b of spool 41 is adapted to abut against large diameter portion 27c of pin 27. More specifically, the diameter increase of pin 27 at large diameter portion 27c is larger than the expansion of penetrating hole 41a by notched portion 41b, so that pin 27 abuts at large diameter portion 27c against notched portion 41b while pin 27 is prevented from abutting against the side surface of penetrating hole 41a. Further, in spool 41, penetrating hole 41a and notched portion 41b are formed so as to have a space which is larger than the movable range of pin 27. Therefore, the vertical movement of pin 27 keeping its horizontal axis does not cause pin 27 to abut against spool 41, however, the slide of spool 41 causes notched portion 41b of spool 41 to abut against large diameter portion 27c of pin 27. Namely, pin 27 is slidably integral with spool 41 due to the slide of spool 41.

Cylinder hole 42 is formed therein with a counter pressure chamber 42a on a second side of spool 41 (opposite to the first side of spool 41 connected to main fluid passage 13). A spring 45 is disposed in counter pressure chamber 42a. Spring 45 is interposed between a bottom surface of cylinder hole 42 and a lower end surface of spool 41 so as to press spool 41. Further, pressure fluid charged to HST 1 is partly led to counter pressure chamber 42a so as to press spool 41 against the hydraulic pressure of fluid from main fluid passage 13, as discussed later. Consequently, in cylinder hole 42, spool 41 is pressed downward by pin 44, and is pressed upward by spring 45 and the charged pressure fluid against the downward pressure.

Load controlling system 104 for hydraulic motor 11 will now be described. Load controlling system 104 is also configured in cylinder 40 having cylinder hole 42 constituting load controlling system 4 for hydraulic pump 10. In this regard, cylinder 40 is attached onto the side of housing 12 as mentioned above, so that cylinder 40 is disposed between hydraulic servomechanism 102 for hydraulic motor 11 and maximum swash plate angle holding system 103. Cylinder 40 is provided therein with a spool 141 and others constituting load controlling system 104 for hydraulic motor 11 while cylinder 40 is provided therein with spool 41 and others constituting load controlling system 4 for hydraulic pump 10.

Spool 141 is pushed by pressure fluid supplied into cylinder 40 from main fluid passage 13 of the HST. Therefore, load controlling system 104 controls the tilt angle of movable swash plate 11a of hydraulic motor 11 independently of the tilt operation of movable swash plate 11a by operating hydraulic servomechanism 102 and so on according to the speed control operation device provided on the driver's section in the vehicle.

Cylinder 40 is bored therein with a downwardly opened vertical cylinder hole 142, in which substantially columnar spool 141 is slidably fitted. An opening 140a laterally penetrates a vertical intermediate portion of cylinder 40 corresponding to load controlling system 104 so as to have pin 27 passed therethrough.

A bolt member 49 serving as a slow-return valve 60 is screwed into the opened (bottom) end of cylinder hole 142.

Cylinder 40 is bored therein with a pin hole 40b opened to a portion of cylinder hole 142 above spool 141 fitted in cylinder hole 142. A pin 144 is slidably fitted in pin hole 40b and abuts at one end thereof against a top surface of spool 141.

A fluid passage 40c is formed in cylinder 40, and pin hole 40b is opened through fluid passage 40c to fluid suction-and-delivery port 43a, which is formed in pipe joint 43 provided to load controlling system 4 as mentioned above, so as to lead pressure fluid from main fluid passage 13 into pin hole 40b.

In this regard, as shown in FIGS. 5, 8, 9 and others, load controlling system 4 has a fluid gallery 46, which is an annular groove formed on pipe joint 43 between pipe joint 43 and cylinder hole 42, and is opened to fluid suction-and-delivery port 43a through a fluid hole 43d. On the other hand, load controlling system 104 has a fluid gallery 146, which is a portion of pin hole 40b on a side of pin 144 opposite to the side of pin 144 contacting spool 141. Fluid galleries 46 and 146 are connected to each other through fluid hole 40c. Therefore, pressure fluid in fluid suction-and-delivery port 43a is led into pin hole 40b through fluid passage 40c so as to slide pin 144 correspondingly to the hydraulic pressure in main fluid passage 13. For example, when the hydraulic pressure in main fluid passage 13 is increased, pin 144 is pushed outward from pin hole 40b so that spool 141 is pressed and slid downward by pin 144.

Spool 141 is bored at a substantially longitudinally middle portion thereof by a vertical long penetrating hole 141a through which pin 27 is passed. Penetrating hole 141a is opened to opening 140a of cylinder 40 while spool 141 is fitted in cylinder hole 142. Since cylinder 40 is interposed between housing 12 and casing 30, opening 140a is opened at one side thereof to openings 12a and 21a formed in the respective side surfaces of housing 12 and piston 21, and is opened at the other side thereof to opening 30c formed in the side surface of casing 30. Opening 140a of cylinder 40, penetrating hole 141a of spool 141 and others constitute a free-passage space, in which pin 27 is disposed so as to penetrate load controlling system 104 (including cylinder 40 and spool 141) in the shorter direction of load controlling system 104.

Spool 141 is formed with a notched portion 141b at an edge around the opening of penetrating hole 141a so as to expand penetrating hole 141a. Similar to that of load controlling system 4, notched portion 141b is adapted to abut against large diameter portion 27c of bar-shaped pin 27, so that pin 27 is slidably integral with spool 141 due to the slide of spool 141.

Cylinder hole 142 has a counter pressure chamber 142a below spool 141 therein, i.e., between spool 141 and bolt member 49. Pressure fluid charged to HST 1 is partly led to counter pressure chamber 142a so as to press spool 141 against the hydraulic pressure of fluid from main fluid passage 13, as discussed later. Consequently, in cylinder hole 142, spool 141 is pressed downward by pin 144, and is pressed upward by the charged pressure fluid against the downward pressure.

Unless load controlling system 104 for hydraulic motor 11 is actuated, i.e., while pin 144 is withdrawn into pin hole 40b (as shown in FIG. 10 and others) and movable swash plate 11a is disposed at the maximum tilt angle, large diameter portion 27c of pin 27 substantially abuts against the bottom side of notched portion 141b.

Load controlling system 104 having the above structure controls movable swash plate 11a of hydraulic motor 11 so as to reduce the tilt angle of movable swash plate 11a (to increase the displacement of hydraulic motor 11), thereby controlling torque.

In HST 1 having the above configuration, apart from the control of tilt angles of movable swash plates 10a and 11a by speed control operation levers 29, when engine 15 receives a load torque, load controlling system 4 or 104 controls a tilt angle of movable swash plate 10a or 11a of hydraulic pump 10 or motor 11 so as to prevent engine 15 from stalling.

In the present embodiment, HST 1 is speed-controlled (accelerated) so that movable swash plate 11a of hydraulic motor 11 is tilted from its maximum tilt angle in the direction for reducing the displacement of hydraulic motor 11 after the displacement of hydraulic pump 10 reaches the maximum. However, with respect to the load control by load controlling systems 4 and 104, if movable swash plate 11a has been tilted from its initial position, firstly, hydraulic motor 11 is controlled for deceleration (for increasing its displacement), and subsequently, hydraulic pump 10 is controlled for deceleration (for reducing its displacement). Therefore, as mentioned above, load controlling system 4 for hydraulic pump 10 has spring 45 disposed in counter pressure chamber 42a so as to regulate the pressure onto spool 41 against the hydraulic pressure from main fluid passage 13.

In other words, due to load controlling systems 4 and 104, the tilt angle of movable swash plate 10a of hydraulic pump 10 is mainly controlled in a low speed range (e.g., one third of the whole speed range), and the tilt angle of movable swash plate 11a of hydraulic motor 11 is mainly controlled in a middle-and-high speed range (e.g., the remaining two thirds of the whole speed range). In the low speed range, movable swash plate 10a of hydraulic pump 10 is allowed to rotate while movable swash plate 11a of hydraulic motor 11 is fixed at the maximum tilt angle. At the transition of increased set speed from the speed range into the middle-and-high speed range, the tilt angle of movable swash plate 10a of hydraulic pump 10 reaches the maximum, and immediately, movable swash plate 10a of hydraulic pump 10 is fixed, and movable swash plate 11a of hydraulic motor 11 is allowed to rotate to reduce its tilt angle.

A hydraulic circuit of HST 1 having the above configuration will be described with reference to the hydraulic circuit diagram of FIG. 10. A charge pump (hydraulic pump) 50 for charging operating fluid to main fluid passages 13 (13a and 13b) has a pump shaft 51, which is driven by engine 15 so that charge pump 50 sucks fluid from a fluid tank 52.

A charge fluid passage 16 is connected to a delivery port of charge pump 50 so as to supply operating fluid into HST 1 through a filter 53. In this regard, operating fluid from charge fluid passage 16 is distributed among (cylinder chamber 24 of) hydraulic servomechanisms 2 and 102, main fluid passages 13a and 13b and others.

Main fluid passages 13a and 13b are provided with respective neutral-check-relief valves 57 each of which is interposed between charge fluid passage 16 and each of main fluid passages 13a and 13b. A charge relief valve 54 is provided on charge fluid passage 16 (see FIGS. 2 and 4). When hydraulic pressure in charge fluid passage 16 exceeds a threshold value, charge relief valve 54 is opened to release operating fluid from charge fluid passage 16 to a fluid sump 56 formed in housing 12 so as to regulate the amount of operating fluid.

Drive shaft 10b of variable displacement hydraulic pump 10 receives the driving force from engine 15 so as to rotate cylinder block 10c and others of hydraulic pump 10. Hydraulic pump 10 is fluidly connected to variable displacement hydraulic motor 11 through main fluid passages 13a and 13b so as to deliver fluid to hydraulic motor 11. As mentioned above, hydraulic servomechanism 2, neutral-position holding system 3 and load controlling system 4 controls the tilt angle of movable swash plate 10a of hydraulic pump 10. The pressure fluid supplied from charge fluid passage 16 to hydraulic servomechanism 2 is finally drained to fluid sump 56 in housing 12.

Load controlling system 4 for hydraulic pump 10 is supplied with fluid led from main fluid passage 13 through a load-controlling fluid passage 14, so as to slide spool 41 fitted in cylinder 40.

Hydraulic servomechanism 102, maximum swash plate angle holding system 103, load controlling system 104 and others are connected to hydraulic motor 11 so as to control the tilt of movable swash plate 11a, similar to those of hydraulic pump 10. Hydraulic motor 11 fluidly connected to hydraulic pump 10 through main fluid passages 13a and 13b is supplied with fluid delivered from hydraulic pump 10 so as to rotate cylinder block 11c and others, thereby rotating driven shaft 11b. Driven shaft 11b of hydraulic motor 11 is drivingly connected to a drive shaft for driving an axle and a drive shaft for driving a working device.

Load controlling system 104 for hydraulic motor 11 is supplied with fluid led from main fluid passage 13 through load-controlling fluid passage 14, so as to slide spool 141 fitted in cylinder 40.

The space in cylinder hole 42 of load controlling system 4 on a side of spool 41 opposite to pin 44, i.e., counter pressure chamber 42a of load controlling system 4, is connected through a counter pressure fluid passage 17 to the space in cylinder hole 142 of load controlling system 104 on a side of spool 141 opposite to pin 144, i.e., counter pressure chamber 142a of load controlling system 104.

Counter pressure fluid passage 17 is connected to charge fluid passage 16. A check valve 47 and a counter pressure valve (relief valve) 48 are interposed in parallel between counter pressure fluid passage 17 and charge fluid passage 16. More specifically, check valve 47 and counter pressure valve 48 are interposed in parallel between counter pressure fluid passage 17 and a fluid passage 18 branched from charge fluid passage 16 (see FIG. 3).

Counter pressure fluid passage 17 has an orifice 61 adjacent to load controlling system 4, and has slow-return valve 60 adjacent to load controlling system 104.

Due to this configuration, check valve 47 prevents fluid from backflowing from counter pressure fluid passage 17 to charge fluid passage 16. When hydraulic pressure fluid passage 17 exceeds a threshold value, counter pressure valve 48 is opened to release operating fluid from counter pressure fluid passage 17 to fluid passage 18 so as to regulate the amount of fluid.

In this way, check valve 47 and counter pressure valve 48 are interposed between charge fluid passage 16 and counter pressure fluid passage 17 connecting load controlling systems 4 and 104 to each other, thereby preventing hunting caused by pulsation of hydraulic pressure from charge fluid passage 16.

As mentioned above, HST 1 according to the invention comprises: variable displacement hydraulic pump 10 provided with movable swash plate 10a; variable displacement hydraulic motor 11 provided with movable swash plate 11a; the closed circuit connecting hydraulic pump 10 and motor 11 to each other through main fluid passage 13; hydraulic servomechanism 2 and 102 for controlling tilt angles of respective movable swash plates 10a and 11a of respective hydraulic pump 10 and motor 11; pins 27 serving as the speed-controlling motive members attached to respective hydraulic servomechanisms 2 and 102, wherein pins 27 interlock with respective movable swash plates 10a and 11a and are moved by operating respective speed control operation levers 29; and load controlling systems 4 and 104 attached to respective hydraulic servomechanisms 2 and 102. Each of load controlling systems 4 and 104 includes the actuator (including cylinder 40 and spool 41 or 141) for moving pin 27 in a direction for deceleration. Fluid is led from main fluid passage 13 to the actuator so as to serve as an element for detecting load and as hydraulic pressure fluid for actuating the actuator.

Main fluid passage 13 includes the pair of main fluid passages. One main fluid passage (referred to main fluid passage 13a) is higher-pressurized during forward traveling (so as to rotate hydraulic motor 11 for forward traveling), and the other main fluid passage (referred to main fluid passage 13b) is higher-pressurized during backward traveling (so as to rotate hydraulic motor 11 for backward traveling). A pair of check valves 58 are connected to the respective main fluid passages, so that fluid is led from either of the main fluid passages to the actuator through corresponding check valve 58 (see FIG. 10).

In this regard, as mentioned above, load controlling systems 4 and 104 are supplied with pressure fluid, serving as the load detection element and the operating fluid for the actuators of load controlling systems 4 and 104, from main fluid passage 13 through load-controlling fluid passage 14. More specifically, as shown in FIG. 10, one check valve 58 is provided on a fluid passage 14a branched from main fluid passage 13a to be higher-pressurized for forward traveling, and the other check valve 58 is provided on a fluid passage 14b branched from main fluid passage 13b to be higher-pressurized for backward traveling, so as to lead pressure fluid from either of main fluid passages 13a and 13b to load controlling systems 4 and 104.

Due to this structure, when HST 1 travels forward, load controlling fluid passage 14 leads pressure fluid from higher-pressurized main fluid passage 13a to load controlling systems 4 and 104 through check valve 58 on fluid passage 14a, so that load controlling system 4 and 104 use the variation of hydraulic pressure in main fluid passage 13a representing the variation of load on engine 15. On the other hand, when HST 1 travels backward, load controlling fluid passage 14 leads pressure fluid from higher-pressurized main fluid passage 13b to load controlling systems 4 and 104 through check valve 58 on fluid passage 14b, so that load controlling system 4 and 104 use the variation of hydraulic pressure in main fluid passage 13b representing the variation of load on engine 15.

As mentioned above, HST 1 is provided with variable displacement hydraulic pump 10 and variable displacement hydraulic motor 11, and HST 1 is provided with hydraulic servomechanisms 2 and 102 for controlling tilt angles of movable swash plate 10a and 11a of respective hydraulic pump 10 and motor 11. Each of hydraulic servomechanisms 2 and 102 has swash plate angle control valve 23 constituted by incorporating spool 22 in piston 21 slidably disposed in cylinder chamber 24.

Each of hydraulic servomechanisms 2 and 102 changes the relative position of spool 22 to piston 21 to supply pressure fluid into one of pressure reception chambers 20a and 20b on opposite sides on piston 21 in cylinder chamber 24 in the slide direction of piston 21, so as to slide piston 21 for tilting movable swash plate 10a or 11a connected to piston 21 through pin shaft 25, thereby changing the displacement of hydraulic pump 10 or motor 11.

As mentioned above, charge pump 50 is driven by engine 15 so as to charge pressure fluid to HST 1, and each of hydraulic servomechanisms 2 and 102 is supplied with the pressure fluid charged from charge pump 50 to pressure reception chambers 20a and 20b.

In this regard, hydraulic servomechanism 2 for hydraulic pump 10 and hydraulic servomechanism 102 for hydraulic motor 11 are provided with respective flow-determining valves 55 for limiting respective flow amounts of the operating fluid supplied from charge fluid passage 16. Due to flow-determining valves 55 provided to respective hydraulic servomechanisms 2 and 102, the flow amounts of fluid to respective swash plate angle control valves 23 of hydraulic servomechanisms 2 and 102 are controlled individually (see FIG. 10).

As shown in FIG. 4, each bolt member 90 is screwed into a hole 12b formed in an end portion of housing 12 of HST 1 so as to be embedded into housing 12, and each flow-determining valve 55 is configured in bolt member 90 so as to limit the flow amount of operating fluid introduced from charge fluid passage 16 into piston 21 (cylinder chamber 24) of each of hydraulic servomechanisms 2 and 102 through fluid passage 19. Fluid passed through flow-determining valve 55 is introduced into cylinder chamber 24 of each of hydraulic servomechanisms 2 and 102 through a fluid passage 21b connected to hole 12b.

In this structure, hydraulic servomechanism 2 for controlling the tilt angle of movable swash plate 10a of hydraulic pump 10 is provided with a positioning means 89 provided to at least one of pressure reception chambers 20a and 20b. When engine 15 is stationary, positioning means 89 sets piston 21 to its neutral position for stopping fluid supply to pressure reception chambers 20a and 20b while spool 22 is disposed at a position corresponding to the neutral position of movable swash plate 10a.

In the present embodiment, as shown in FIG. 11 and others, positioning means 89 is provided to pressure reception chamber 20b of cylinder chamber 24 below piston 21 (supplied with fluid for backward traveling).

Positioning means 89 moves piston 21 to the neutral position and holds it at the neutral position when engine 15 for driving charge pump 50 stops so as to stop the charged pressure fluid supply from charge pump 50 to cylinder chamber 24. In this regard, in cylinder chamber 24, when spool 22 slides, charged pressure fluid is supplied to pressure reception chamber 20a or 20b so as to change the relative position of piston 21 to spool 22, thereby sliding piston 21. When engine 15 is stationary, i.e., when the supply of charged pressure fluid to cylinder chamber 24 is stopped, piston 21 is not or little influenced by change of hydraulic pressure caused by the slide of spool 22. Further, when engine 15 is stationary, due to operation of the speed controlling operation device disposed in the driver's section of the vehicle, spool 22 is located with speed controlling operation lever 29 and pin 27 at the position corresponding to the neutral position of movable swash plate 10a of hydraulic pump 10.

In this state, positioning means 89 holds piston 21 at its neutral position for stopping fluid supply to pressure reception chambers 20a and 20b.

As shown in FIG. 11, positioning means 89 includes a spring 91 serving as an elastic member, a spring retainer 92, and a retaining ring 93 engaging spring retainer 92 to piston 21.

On the side of piston 21 toward positioning means 89 (lower side in FIG. 11), piston 21 has a cylindrical projection 21f, which is a peripheral edge of piston 21 projecting in a substantially cylindrical shape so as to surround a space as a part of pressure reception chamber 20b.

Spring retainer 92 is substantially shaped in a hat, that is, a cylindrical member having a flange 92a at its end. Spring retainer 92 having flange 92a faced to spool 22 (upward in FIG. 11) is fitted in cylindrical projection 21f of piston 21 through flange 92a so as to be slidable relative to piston 21.

Retaining ring 93 is fitted on the inner periphery of a tip portion of cylindrical projection 21f of piston 21, so as to retain flange 92a of spring retainer 92 in the inner space of cylindrical projection 21f.

In cylindrical projection 21f of piston 21, spring 91 is interposed between piston 21 and spring retainer 92. Spring 91 abuts at one end thereof (upper end in FIG. 11) against a bottom surface 21g of piston 21, and is caught at the other end thereof (lower end in FIG. 11) in spring retainer 92. Spring 91 biases spring retainer 92 so as to engage flange 92a to retaining ring 93.

Spring retainer 92 has a bottom portion 92b which projects outward from the tip of cylindrical projection 21f of piston 21 so as to be able to abut against a bottom surface 24a of cylinder chamber 24 when flange 92a abuts against retaining ring 93.

A hole serving as a fluid gallery 24b is bored in cylinder chamber 24 from bottom surface 24a. A drain hole 92c is formed in bottom portion 92b of spring retainer 92. Therefore, when bottom portion 92b of spring retainer 92 abuts against bottom surface 24a of cylinder chamber 24, the inner space of cylindrical projection 21f is connected to fluid gallery 24b through drain hole 92c.

In positioning means 89 having the above structure, while piston 21 having been disposed at the lowest position (where the tip of cylindrical projection 21f has abutted against bottom surface 24a of cylinder chamber 24) slides before a gap between the tip of cylindrical projection 21f and bottom surface 24a of cylinder chamber 24a is increased beyond the length of the portion of spring retainer 92 projecting outward from cylindrical projection 21f, bottom portion 92b of spring retainer 92 is separated from bottom surface 24a and is slidably integral with piston 21.

On the contrary, while piston 21 having bottom portion 92b of spring retainer 92 separated from bottom surface 24a of cylinder chamber 24 slides toward pressure reception chamber 20b, bottom portion 92b of spring retainer 92 projecting outward from the tip of cylindrical projection 21f comes to abut against bottom surface 24a of cylindrical chamber 24, and then, due to the slide of piston 21 against the biasing force of spring 91, retainer 93 is released from flange 92a of spring retainer 92, so that the tip of cylindrical projection 21f of piston 21 comes to abut against bottom surface 24a of cylinder chamber 24.

With respect to positioning means 89, the position, where spring retainer 92 has bottom portion 92b abutting against bottom surface 24a of cylinder chamber 24 and has flange portion 92a engaged to retaining ring 93, corresponds to the vicinity of the position of piston 21 corresponding to the neutral position of movable swash plate 10a of hydraulic pump 10 (hereinafter referred to as the neutral position of piston 21). In other words, when piston 21 is disposed in the direction for backward traveling (downward in FIG. 11) from the vicinity of its neutral position, bottom portion 92b of spring retainer 92 abuts against bottom surface 24a of cylinder chamber 24 and piston 21 slides against the biasing force of spring 91.

Due to positioning means 89 provided to pressure reception chamber 20b, when engine 15 is stopped and no charged pressure is applied onto swash plate angle control valve 23, piston 21 is located at the position corresponding to the neutral position of movable swash plate 10a. In other words, if piston 21 exists in the direction for backward traveling from the neutral position the moment that swash plate angle control valve 23 comes to be supplied with no charged pressure fluid, piston 21 slides to the vicinity of the neutral position due to the biasing force of spring 91 of positioning means 89, and is held at the neutral position by engaging retaining ring 93 to flange 92a of spring retainer 92.

Therefore, the working vehicle can be prevented from starting creeping when engine 15 is restarted, and the working vehicle can be surely stopped on a slope or so on.

In other words, when engine 15 is stationary, piston 21 is located in the vicinity of the neutral position. Thus, when engine 15 is cranked, movable swash plate 10a of hydraulic pump 10 is disposed in the vicinity of the neutral position so as to require a very small torque for driving HST 1, so that the braking force (resistance against the driving power transmitted from engine 15) required for preventing the working vehicle from unexpectedly starting creeping during start of engine 15 is very small.

Further, in an apparatus having HST 1, such as an HMT, piston 21 is prevented from being stopped at a position corresponding to an angle of movable swash plate 10a of hydraulic pump 10 causing the idling of HST, thereby enabling a working vehicle having the apparatus to be surely kept stationary on a slope.

Alternatively, in hydraulic servomechanism 2 for hydraulic pump 10, both of pressure reception chambers 20a and 20b in cylinder chamber 24 on the opposite sides of piston 21 in the slide direction of piston 21 may be provided with respective positioning means 89.

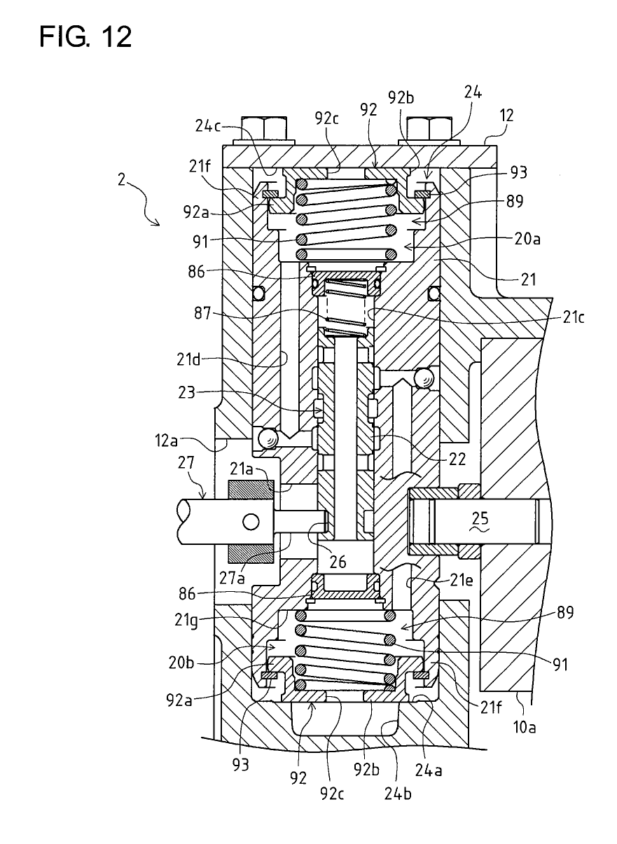

In this case, as shown in FIG. 12, piston 21 is further formed with an additional cylindrical projection 21f on the top thereof (in the side direction for forward traveling), and is provided with an additional positioning means 89 fitted to additional cylindrical projection 21f. Additional positioning means 89 includes spring 91, spring retainer 92 and retaining ring 93, similar to those of the above-mentioned positioning means 89. Therefore, the pair of positioning means 89, provided to respective pressure reception chambers 20a and 20b on the opposite sides of piston 21, locate piston 21 into the vicinity of the neutral position when engine 15 is stationary.

More specifically, the position of piston 21 corresponding to the neutral position of movable swash plate 10a of hydraulic pump 10 is defined as the position, where spring retainer 92 of positioning means 89 on pressure reception chamber 20a has bottom portion 92a abutting against an upper surface 24c of cylinder chamber 24 and has flange 92a engaged to retaining ring 93, and spring retainer 92 of positioning means 89 on pressure reception chamber 20b has bottom portion 92a abutting against bottom surface 24a of cylinder chamber 24 and has flange 92a engaged to retaining ring 93.

The slide of piston 21 in cylinder chamber 24 from its neutral position in the direction for forward traveling (toward pressure reception chamber 20a) has to overcome the biasing force of spring 91 of positioning means 89 provided to pressure reception chamber 20a. The slide of piston 21 in cylinder chamber 24 from its neutral position in the direction for backward traveling (toward pressure reception chamber 20b) has to overcome the biasing force of spring 91 of positioning means 89 provided to pressure reception chamber 20b.

Due to the pair of positioning means 89 provided to respective pressure reception chambers 20a and 20b, if engine 15 is stopped so as to stop the supply of charged pressure fluid to swash plate angle control valve 23, piston 21 is surely located into the vicinity of its neutral position regardless of whether piston 21 has been disposed in the direction for forward traveling from the neutral position or in the direction for backward traveling from the neutral position.

Therefore, whether the last traveling direction of the working vehicle is forward or backward, the working vehicle can be prevented from creeping when engine 15 is restarted, and the working vehicle can be surely stopped on a slope.

On the other hand, as shown in FIG. 13, hydraulic servomechanism 102 for controlling the tilt angle of movable swash plate 11a of hydraulic motor 11 is provided with biasing means 95 in pressure reception chamber 20a on the side of piston 21 in the slide direction for tilting movable swash plate 11a toward its neutral position. Biasing means 95 is provided for locating piston 21 at the maximum swash plate angle position for stopping the supply of pressure fluid to pressure reception chambers 20a and 20b, in correspondence to spool 22 disposed at the position corresponding to the maximum tilt angle of movable swash plate 11a when engine 15 is stationary.

When engine 15 for driving charge pump 50 is stopped so as to stop the supply of pressure fluid charged from charge pump 50 into cylinder chamber 24, biasing means 95 moves piston 21 to the maximum swash plate angle position and holds it at the maximum swash plate angle position. In this regard, as mentioned above, when engine 15 is stationary, i.e., when the supply of charged pressure fluid to cylinder chamber 24 is stopped, piston 21 is not or little influenced by change of hydraulic pressure caused by the slide of spool 22. Further, when engine 15 is stationary, due to operation of the speed controlling operation device disposed in the driver's section of the vehicle, spool 22 is located with speed controlling operation lever 29 and pin 27 at the position corresponding to the maximum tilt angle of movable swash plate 11a of hydraulic motor 11.

In this state, due to biasing means 95, piston 21 is held at the maximum swash plate angle position for stopping the supply of pressure fluid to pressure reception chambers 20a and 20b.

As shown in FIG. 13, in the present embodiment, a spring, i.e., an elastic member, serves as biasing means 95. Biasing means 95 is interposed between an upper surface 24d of cylinder chamber 24 and an end of piston 21, so as to bias piston 21 toward the maximum swash plate angle position. In this regard, piston 21 has a recess 21h, which is formed in a substantially cylindrical peripheral edge projecting from the end of piston 21 so as to be provided therein with a space as a part of pressure reception chamber 20a. Biasing means 95 is fitted at one end thereof into recess 21h. A fluid gallery 24e is recessed from upper surface 24d of cylinder chamber 24.

Due to biasing means 95 in pressure reception chamber 20a, piston 21 is biased so as to be located at the maximum swash plate angel position when no charged hydraulic pressure caused by the slide of spool 22 is supplied. More specifically, when hydraulic motor 11 is driven, and when spool 22 is slid with speed controlling operation lever 29 and pin 27 in the direction for reducing the swash plate angle (for acceleration), piston 21, having been disposed at the maximum swash plate angle position, slides in the direction for reducing the swash plate angle (for acceleration) against the force of biasing means 95.

Due to biasing means 95, when engine 15 is stopped, and when swash angle plate control valve 23 comes to be supplied with no charged hydraulic pressure, piston 21 is located at the position corresponding to the maximum swash plate angle of movable swash plate 11a. In other words, when swash plate angle control valve 23 comes to be supplied with no charged hydraulic pressure, biasing means 95 slidably pushes cylinder 21 and locates it at the maximum swash plate angle position (the lowest position in FIG. 13).

In this way, the vehicle can have sure engine brake and can be surely stopped on a slope. In this regard, when engine 15 is stationary, piston 21 is retained at the maximum swash plate angle position so as to have the maximum displacement of hydraulic motor 11, thereby increasing the operating fluid flowing through hydraulic motor 11 for driving driven shaft 11b. Accordingly, the torque of hydraulic motor 11 for rotating driven shaft 11b is increased so as to increase the barking action onto driven shaft 11b due to the torque. Consequently, when the working vehicle is stopped on a slope, the engine brake is applied sufficiently to overcome the load transmitted from an axle of the vehicle to driven shaft 11b of hydraulic motor 11.

It is further understood by those skilled in the art that the foregoing description is a preferred embodiment of the disclosed apparatus and that various changes and modifications may be made in the invention without departing from the scope thereof claimed as follows.

What is claimed is:

1. A hydrostatic stepless transmission comprising:
a variable displacement hydraulic pump; and
a hydraulic servomechanism including
a cylinder chamber,
a piston slidably fitted in the cylinder chamber,
a slidable member disposed in the piston so as to constitute a swash plate angle control valve for the hydraulic pump,
a pair of pressure reception chambers formed in the cylinder chamber on opposite sides of the piston in the slide direction of the piston, wherein by changing a position of the slidable member relative to the piston, one of the opposite pressure reception chambers is supplied with pressure fluid so as to slide the piston and to tilt a movable swash plate of the hydraulic pump connected to the piston, thereby changing a displacement of the hydraulic pump, and
positioning means provided to at least one of the pressure reception chambers, wherein the positioning means locates the piston at a neutral position for stopping pressure fluid supply to the pressure reception chamber hydraulic servomechanism, in correspondence to the slidable member located at a position corresponding to a neutral position of a movable swash plate of the hydraulic pump when an engine for driving another hydraulic pump for supplying pressure fluid into the pressure reception chambers is stationary.

2. A hydrostatic stepless transmission comprising:
a variable displacement hydraulic motor; and
a hydraulic servomechanism including
a cylinder chamber,
a piston slidably fitted in the cylinder chamber,
a slidable member disposed in the piston so as to constitute a swash plate angle control valve for the hydraulic motor,
a pair of pressure reception chambers formed in the cylinder chamber on opposite sides of the piston in the slide direction of the piston, wherein by changing a position of the slidable member relative to the piston, one of the opposite pressure reception chambers is supplied with pressure fluid so as to slide the piston and to tilt a movable swash plate of the hydraulic motor connected to the piston, thereby changing a displacement of the hydraulic motor, and
biasing means disposed in the pressure reception chamber on the slide side of the piston for moving the movable swash plate toward a neutral position, wherein the biasing means biases the piston so as to locate the piston at a position corresponding to a maximum swash plate angle of the movable swash plate of the hydraulic motor for stopping supply of fluid to the pressure reception chamber, in correspondence to the slidable member located at a position corresponding to the maximum swash plate angle of the movable swash plate when an engine for driving a hydraulic pump for supplying pressure fluid into the pressure reception chambers is stationary.
